(19) United States
(12) Patent Application Publication
(10) Pub. No.: US 2011/0180003 A1
(43) Pub. Date: Jul. 28, 2011

(54) INSECT LOADING SYSTEM

(75) Inventors: Andrew Durnford, Wiltshire (GB); Mathilde Briens, Harpenden (GB); Mark Haite, Sussex (GB); David Grant, Milton (GB); David Westley, Harpenden (GB); Kenneth Cherry, Bedford (GB); Thomas Howard, Henley-On-Thames (GB)

(73) Assignee: INSCENTINEL LIMITED, London (GB)

(21) Appl. No.: 13/119,321

(22) PCT Filed: Sep. 10, 2009
(86) PCT No.: PCT/GB09/51166

§ 371 Date: Apr. 13, 2011

(30) Foreign Application Priority Data
Sep. 16, 2008 (GB) 0816917.9

(51) Int. Cl. A01K 15/04; A01K 53/00; A01K 1/03

(52) U.S. Cl. 119/6.5; 119/417; 119/843

(57) ABSTRACT

A method of collecting and loading a plurality of insects of a particular type into respective insect holders includes extracting a plurality of insects from an insect habitat to a storage chamber which is operable to allow access to a plurality of exit holes and allowing access to the exit holes, followed by luring and/or compelling the insects to leave the storage chamber via the exit holes for subsequent loading into an insect holder.

### FIELD OF THE INVENTION

The invention relates to a method of collecting and loading a plurality of insects, particularly forager honey bees, into respective insect holders for subsequent use in the detection of odours.

### BACKGROUND

The use of insects, particularly of bees, for detection of odours is well-known. Insects including bees, wasps, moths, aphids etc. have much greater sensitivity to odours than the best physical analytical techniques including gas chromatography.

Such insects can be trained or conditioned to respond with high accuracy and specificity to a specific odour in a detectable manner e.g. by measuring electrical signals in antennae (electroantennography) or observing physical movements, such as proboscis extension reflex.

WO 03/056292 discloses an apparatus and system of using insects to detect odours whilst restrained in an insect holder which is removably associated with a detector apparatus. The removable nature of the holder allows the insects to be raised and conditioned at one location and transferred to another location where the detector unit is located.

However, insects for use in such detection schemes must be carefully treated with particular attention paid to their training regime and handling in order that accurate odour detection can be achieved.

In particular, it is important that insects are raised in as natural an environment as possible so that the natural reactions, upon which the detection method relies, are reliably reproduced during detection. Therefore, insects for use in such detection methods are typically raised in a habitat, e.g. hive, so that their natural behaviour develops as if in the wild.

Known methods of taking insects, e.g. bees, from a hive involve extraction by sucking air so that a number of insects are captured in a capturing chamber. Once captured they are transferred to a storage chamber, typically by a handler blowing them into the storage chamber. Once in the storage chamber they are fed with a feeder being added manually. This is followed by a longer starvation period (e.g. 12 hr), to enable the bees to exchange food so that they are all at substantially the same level of hunger and ready for training.

The bees are typically chilled by refrigerating the storage chamber so that the bees become inactive, enabling a handler to catch one at a time for manual insertion into an insect holder. As the bee warms up it recovers its full mobility and is ready to be trained and used in a detection system.

The training regime then takes place in known manner, involving exposure to the target odour whilst being provided with food.

Practical application of insects in an odour detection system, e.g. for use in airports, demands that a large number of insects are used in order that detection is reliable. Furthermore, because any given insect can be trained for a single odour at a time, many insects may need to be employed to reliably detect a range of odours.

Known methods of loading insects into insect holders are not capable of coping with such quantities of insects because they are too involved and require too much manual handling.

### SUMMARY OF THE INVENTION

The invention relates to a method of collecting and loading a plurality of insects of a particular type into respective insect holders, comprising extracting a plurality of insects from an insect habitat to a storage chamber which is operable to allow access to a plurality of exit holes and allowing access to the exit holes, followed by luring and/or compelling the insects to leave the storage chamber via the exit holes for subsequent loading into an insect holder.

Thus, a number of insects may be captured and then transferred to exit holes for subsequent loading into insect holders with minimal manual involvement.

In a preferred embodiment, the volume of the chamber within which the insects can move is alterable and the method involves reducing the volume thereby to compel the insects to leave the storage chamber via the exit holes.

Preferably the exit holes lead to a respective passageway, e.g. a tube, which is sized such that the insect is prevented from turning around. Such passageways typically lead to an insect holder. Once in a passageway the insect is encouraged, whether by luring it with an attractant or by physical force, to pass along the passageway for loading in an insect holder.

The insects may be lured by using light or odours for example of food or pheromones.

The method of the invention is applicable with a wide range of different insects, with a particular passageway and insect holder being designed and dimensioned to hold an insect of a particular type. The invention finds particular application in a holder for forager honey bees (species Apis mellifera).

Preferably the insects, e.g. forager honey bees, are also fed in the storage chamber and subsequently starved before they exit the storage chamber.

The insects are typically extracted by sucking air from the habitat which pulls in a plurality of insects into a capture chamber. This may be achieved for example by using a device based on a vacuum cleaner principle. Once a sufficient number of insects are captured then the chamber is sealed to prevent the insects from escaping. The captured insects may then be passed to the storage chamber, e.g. by blowing the insects from the capture chamber to the storage chamber.

However, in a preferred embodiment, the capture chamber and storage chamber are one and the same. Utilising the capture chamber as the storage chamber reduces the number of steps in the loading process and thus makes it more efficient.

Thus, the invention also relates to an insect capture and storage chamber which is operable to allow access to a plurality of exit holes.

When the capture chamber is also the storage chamber it must be operable to allow access to the exit holes. This may be achieved for example by use of a sliding door or similar arrangement. Preferably however, the capture chamber comprises interchangeable fittings to allow it to perform a variety of functions, as desired.

For example, once captured, a fitting which comprises the exit holes can be positioned over the opening through which the insects entered the chamber. Once the volume is reduced, the insects can then pass through the exit holes. Additionally the capture chamber could have a fitting for feeding the insects. In this way the insects can be captured, fed, starved and moved on with a single device and through a single opening in the chamber having interchangeable fittings.

In order to facilitate the use of interchangeable fittings, preferably the chamber comprises a closing means, e.g. a sliding door, to prevent the insects from escaping when changing a fitting.

A further advantage of having a single capture and storage chamber having interchangeable fittings is that it lends itself to being automated, e.g. by using a programmable timer, further reducing the amount of manual handling involved.

The volume of the chamber can be reduced for example by including a porous plug in the storage chamber which is moveable within the chamber. The plug must be sufficiently porous to allow the passage of air but not the passage of the insects, e.g. a wire frame. By moving the plug, e.g. from one end of the chamber, the volume available for the insects can thus be reduced. Other ways of reducing the volume available for the insects can be envisaged such as arranging for the storage chamber to be collapsible.

The method of the invention is suitable for capturing and loading numerous insects in parallel. Thus, preferably the method of the invention relates to at least 5 insects, preferably at least 10 and could be greatly in excess of this number. A typical range may be from 10 to 100 insects.

As discussed above, the insects typically pass down a passageway to be loaded into an insect holder. In carrying out the method of the invention it is quite possible that more than one insect will leave the storage chamber via the same exit hole. To deal with this problem, preferably the passageway comprises an insect detection means, such as a light sensitive detector, which when triggered, activates a blocking means which blocks the passageway immediately behind the insect which triggered its activation.

The blocking means may be anything which prevents the passage of an insect but care must be taken not to damage any insects in the passageway. For example, when an optical sensor is triggered by a passing insect, the armature of a solenoid could be released to fall on the rear end of the triggering insect. Such an armature would be sufficiently lightweight so as to prevent the insect from being harmed. As the insect passes by the armature will continue its descent behind the insect.

Alternatively, the insect detection means, such as a light sensitive detector, when triggered, activates a means to relocate the passageway, transporting the passageway containing the insect to another physical location for subsequent loading into an insect holder. Advantageously a vacant passageway can then replace the relocated passageway allowing an insect to enter via the same exit hole.

Once the insect passes along the passageway it is lured or physically forced into an insect holder. Insect holders suitable for use in the invention are disclosed in WO 03/055301.

Thus, a suitable insect holder comprises a housing with a chamber adapted to receive an insect of the particular type, the holder comprising a housing with a chamber adapted to receive an insect of the particular type, an inlet to the chamber through which an insect of the particular type can pass to enter the chamber, a head opening to the chamber adapted to permit the head of an insect of the particular type in the chamber to pass therethrough to the exterior of the housing while retaining the insect in the housing, and retaining means for retaining an insect of the particular type in the chamber with the head of the insect protruding through the head opening to the exterior of the housing, such that the insect is unable to turn around in the chamber.

Once the insect is lured or forced into the insect holder it is quite possible that the insect is not in the correct orientation, for example it may be upside down. Therefore, in a preferred embodiment, the insect holder comprises a rotatable passageway, e.g. tube which the insect enters. Once in the insect holder, the insect can then be oriented with respect to the holder by rotating the passageway. The passageway may then be removed from the insect holder, leaving the insect in place in the holder. Preferably the orientation of the insect is determined by use of a camera and associated image recognition software. The software can then output a signal to instruct the reorientation of the insect.

In another aspect, the invention relates to a method of loading an insect into an insect holder comprising a housing, wherein the insect is positioned into the holder whilst also inside a rotatable passageway, dimensioned to prevent the insect from turning around, the orientation of the insect being observed and the insects orientation being corrected by rotating the passageway within which it is confined.

A further advantage of using a rotatable and removable passageway is that it can hold open a barb or other restraining means when in place in the holder. Without the removable passageway such a restraining barb would need to be pushed out of the way by the insect, which could cause damage to the insect. When the passageway is removed, the barb can close, e.g. behind the insect, between thorax and abdomen, or behind its head, holding the insect in place in the holder in the correct orientation. A further advantage is that an opened barb acts to lure the insect as it sees an exit.

In a preferred embodiment the insect enters a portion of the passageway which is detachable from the passageway leading from the exit holes, and is transported in the detachable passageway to a loading station, so that the insect faces the opening to an insect holder. From within the detachable passageway the insect is preferably physically pushed into the insect holder. The detachable passageway may also constitute the rotatable passageway after being inserted into the holder.

The method of loading according to the invention has the additional advantage that it lends itself well to being automated with little or no manual handling.

The invention will now be illustrated, by way of example, with reference to the following figures, in which:

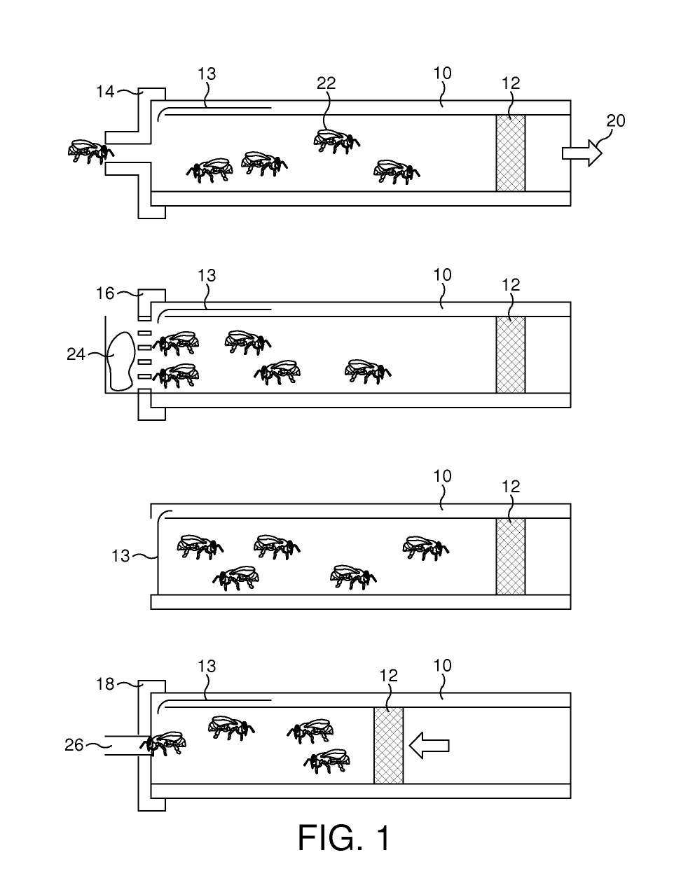

FIG. 1 is a schematic layout of a capture and storage device for use according to the invention.

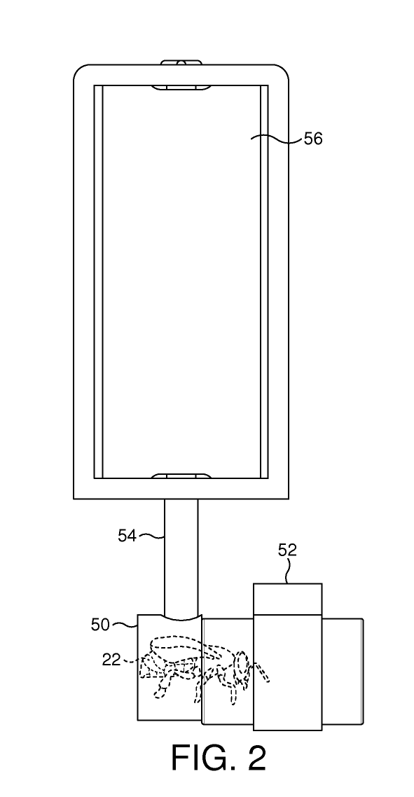

FIG. 2 is a perspective view of an insect in a passageway comprising a blocking means.

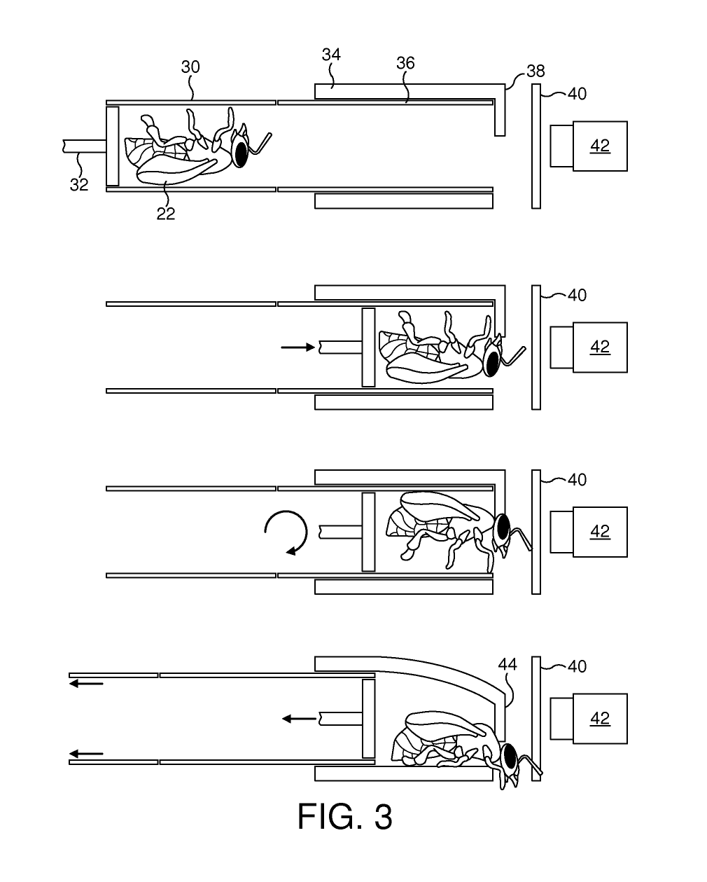

FIG. 3 is a schematic layout of the loading system according to the invention.

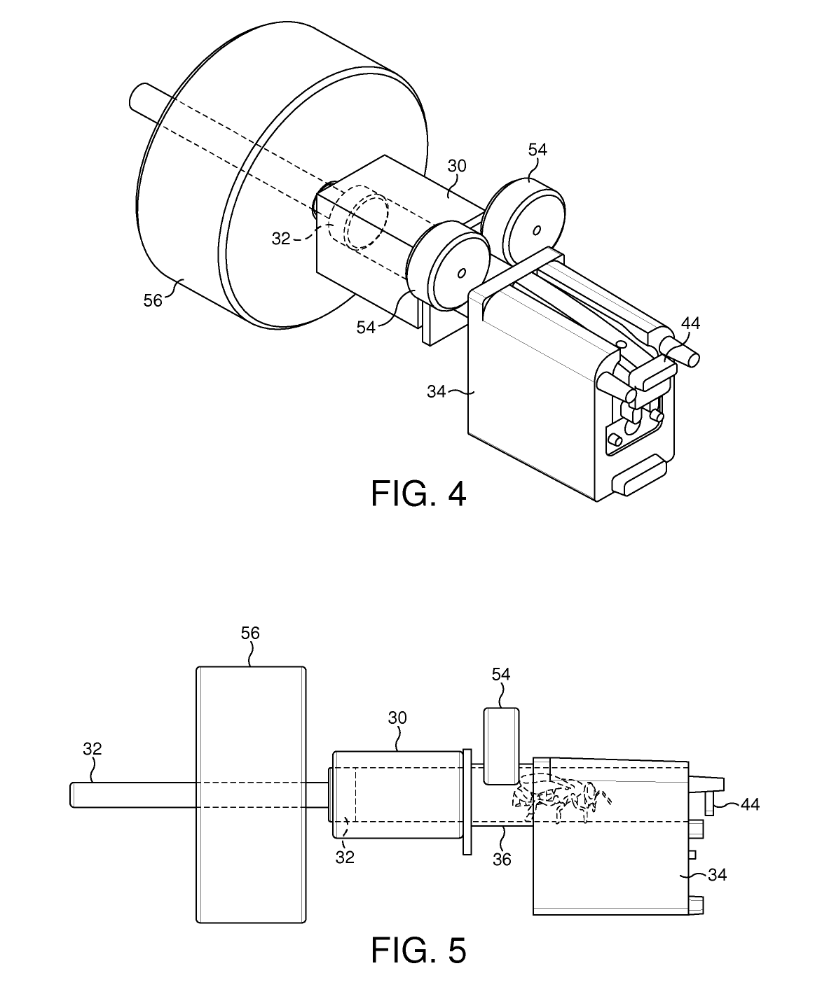

FIG. 4 is a side view of an insect loading system according to the invention.

FIG. 5 is a perspective view of the insect loading system shown in FIG. 4.

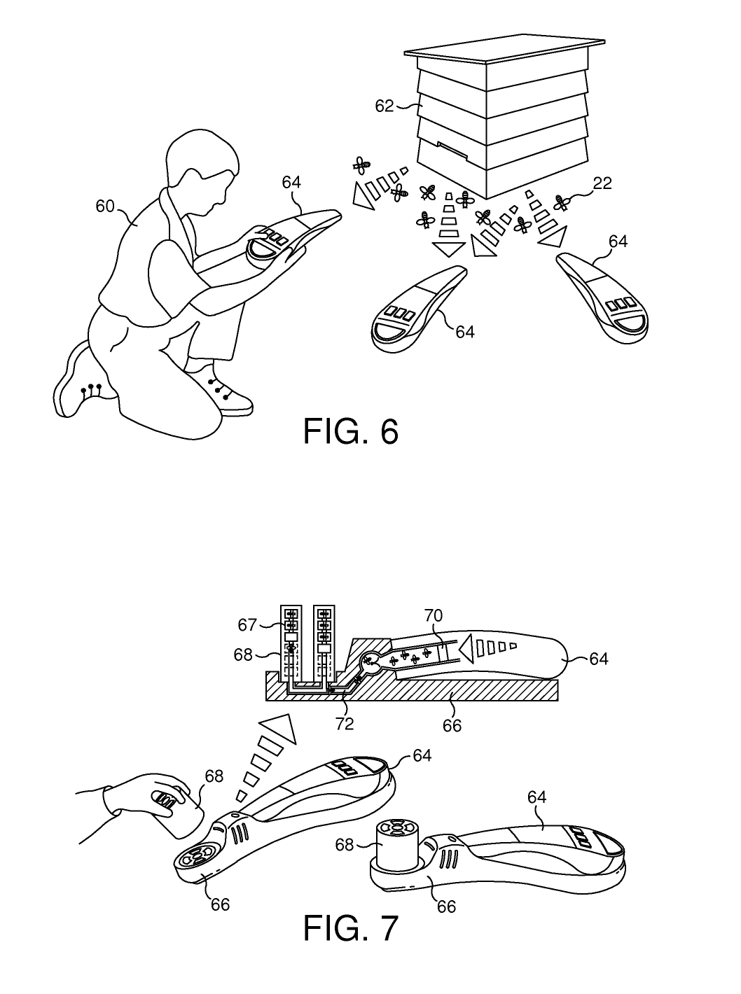

FIG. 6 is a representation of a capture and storage device according to the invention, extracting bees from a hive.

FIG. 7 is a representation of a capture and storage device according to the invention being used with interchangeable fittings.

Referring to the figures, FIG. 1 shows a combined capture and storage chamber 10 comprising a moveable wire grille 12, sliding door 13, and adapted to have interchangeable fittings 14, 16, 18.

During extraction of bees from a hive, an extraction fitting 14 is placed on the end of the chamber 10. Suction is applied from an associated vacuum cleaner device in direction of arrow 20. Movable wire grille 12 is placed at the rear of the chamber, and sliding door 13 is held open. The chamber 10 is placed into a hive and the suction is sufficient to extract bees 22 from their home environment into chamber 10 and remain unharmed. Once a sufficient number of bees are in the chamber, sliding door 13 is closed and the suction turned off.

Fitting 14 is removed and feeder fitting 16 is placed on the end of the chamber 10. A food supply 24 is placed in the feeder fitting and sliding door 13 is opened. The captured bees feed on the food for a defined amount of time.

Sliding door 13 is then closed and feeder fitting 16 is removed. The bees in the chamber are then left without food for several hours, during which time they become hungry and exchange food between each other so that they are all substantially at the same level of hunger.

Exit fitting 18 is then placed on the end of the chamber which comprises ten exit holes 26 of diameter approximately 5 mm so that the forager bees can just fit into them. Sliding door 13 is opened and wire grille 12 is slowly moved towards the exit fitting 18, gradually reducing the volume of the chamber within which the insects can move. Eventually the bees have no option but to leave the chamber 10 via one of the exit holes 26.

Each exit hole 26 has attached a tube (not shown) within which the bee is encouraged to enter e.g. by introducing the odour of food.

FIG. 2 shows a bee 22 passing through a tubular passageway 50. Surrounding the passageway is an optical detection device 52 which when triggered by the passage of the bee activates the armature 54 of a solenoid 56 to descent under its own light weight onto the behind of the bee. The weight of the armature 54 is light enough so that the bee is not damaged. As the bee proceeds along the passageway 50, the armature descends further immediately behind the bee to act as a blocking means, preventing the passage of any additional bees who may have entered the same passageway.

Referring now to FIG. 3 a detachable tube 30, or pod, is shown which was attached to an exit hole 26 and which has been transported to a loading station and comprises a bee 22.

The loading station comprises a plunger 32 for forcing the bee into bee holder 34. The bee holder 34 has contained within it a rotatable and removable tube 36 which has the same diameter as pod 30. The rotatable tube 36 holds open restraining collar 38 so that the bee can freely enter the bee holder.

Plunger 32 slowly forces the bee to enter the bee holder until its head protrudes from the holder. A transparent wall 40 is placed outside the holder to prevent the bee from leaving the bee holder.

Once in place the orientation of the bee is determined by use of camera 42 and associated image recognition software. In this case the bee is upside down. The software outputs a signal to instruct a rotation wheel (not shown) in contact with tube 36 to rotate sufficiently to orient the bee in the tube correctly so that retaining barb 44 is directly behind the head of the bee. The rotation wheel rotates and causes the rotatable tube 36 to rotate accordingly by friction.

Once correctly oriented the rotatable tube 36 is removed from the holder whilst plunger 32 keeps the bee in the holder. As the rotatable tube leaves the holder retaining barb 44 is released to hold the bee in position directly behind its head.

The bee is then ready to be trained to detect a particular odour in known manner.

FIGS. 4 and 5 show a loading station comprising a bee holder 34 contained within it and protruding out slightly a rotatable and removable tube 36. Rotation wheels 54 are in contact with the protruding portion of the rotatable tube 36. Aligned with the rotatable tube is tube 30, or pod, which contains a bee (not shown). At the rear of tube 30 is a plunger 32 and an associated motor 56.

As described in relation to FIG. 3, the plunger 32 forces the bee into the holder 34 until its head protrudes through the bee holder 34. Rotation wheels 54 rotate as instructed to orient the bee accordingly. Rotatable tube 36 is then pulled out of the bee holder, causing head restraint 44 to descend holding the bee in place.

FIG. 6 shows a handler 60 extracting bees 22 from a hive 62 using a capture and storage device 64 utilising suction as the means of capture. More bees 22 may be captured by employing additional storage devices 64. Once in the capture and storage chamber the entrance is sealed off and they are fed, e.g. by exposing food from behind a sliding door or from a separate feeding fitting, and subsequently starved.

FIG. 7 shows the storage device 64 installed in a loading shoe 66 which has fitted a plurality of bee holders 67 in a cartridge 68. Once installed in the shoe 66, the entrance to the storage chamber is exposed and the volume available for the bees is reduced by moving a wire mesh plug 70 towards the entrance. As the volume reduces the bees move out of the chamber via passageway 72 to be loaded in respective bee holders 67.

1. A method of collecting and loading a plurality of insects of a particular type into respective insect holders, comprising extracting a plurality of insects from an insect habitat to a storage chamber which is operable to allow access to a plurality of exit holes and allowing access to the exit holes, followed by luring and/or compelling the insects to leave the storage chamber via the exit holes for subsequent loading into an insect holder.

2. A method according to claim 1, wherein the volume of the chamber within which the insects can move is alterable and involves reducing the volume thereby to compel the insects to leave the storage chamber via the exit holes.

3. A method according to claim 1, wherein the insects are extracted from their habitat into a capture chamber.

4. A method according to claim 3, wherein the capture chamber and the storage chamber are one and the same.

5. A method according to claim 4, wherein the capture chamber comprises interchangeable fittings.

6. A method according to claim 5, wherein the fittings are selected from a suction fitting, an exit hole fitting and a feeding fitting.

7. A method according to claim 1, wherein the insects are fed and subsequently starved before they exit the storage chamber.

8. A method according to claim 1, which involves collecting at least five insects into the storage chamber.

9. A method according to claim 1, wherein the exit holes lead to a respective passageway sized such that the insect is prevented from turning around.

10. A method according to claim 9, wherein the passageways comprise an insect detector means.

11. A method according to claim 10, wherein, when an insect is detected, the detector means triggers a blocking means immediately behind the detected insect.

12. A method according to claim 10, wherein, when an insect is detected, a means to relocate the passageway is activated, transporting the passageway containing the insect to another physical location for subsequent loading in an insect holder.

13. A method according to claim 1, wherein the insect enters the insect holder inside a passageway sized such that the insect is prevented from turning around and rotatable with respect to the insect holder.

14. A method according to claim 13, wherein the orientation of the insect is observed followed by rotating the rotatable passageway until the insect is in the correct orientation with respect to the insect holder.

15. A method according to claim 13, wherein the rotatable passageway is removed from the insect holder and releases a restraining means to keep the insect confined within the insect holder.

16. An insect capture and storage device which is operable to allow access to a plurality of exit holes and is adapted to permit feeding and subsequent exit of captured insects via the exit holes.

17. A method according to claim 2, wherein the insects are extracted from their habitat into a capture chamber.

18. A method according to claim 2, wherein the insects are fed and subsequently starved before they exit the storage chamber.

19. A method according to claim 2, which involves collecting at least five insects into the storage chamber.

20. A method according to claim 2, wherein the exit holes lead to a respective passageway sized such that the insect is prevented from turning around.
